(19) United States
(12) Patent Application Publication
(10) Pub. No.: US 2026/0330210 A1
(43) Pub. Date: Oct. 22, 2026

(54) SYSTEMS AND METHODS OF OPERATING THEREOF, MEMORY SYSTEMS AND METHODS OF OPERATING THEREOF, AND COMPUTER READABLE STORAGE MEDIUMS

(71) Applicant: Yangtze Memory Technologies Holding Co., Ltd., Wuhan (CN)

(72) Inventors: Chunyuan HOU, Wuhan (CN); Yue SHENG, Wuhan (CN); Zongliang HUO, Wuhan (CN)

(21) Appl. No.: 19/414,979

(22) Filed: Dec. 10, 2025

Related U.S. Application Data
(63) Continuation of application No. PCT/CN2025/089667, filed on Apr. 17, 2025.

(51) Int. Cl. G06N 3/065; G06N 3/0499

(52) U.S. Cl. CPC G06N 3/065; G06N 3/0499

(57) ABSTRACT

The implementations of the present application provide a system and a method of operating thereof, a memory system and a method of operating thereof, and a computer readable storage medium. In an implementation, a system includes at least one processor, a non-volatile memory device and a memory controller coupled with the non-volatile memory device, wherein the processor is configured to: perform a prefill operation for large model inference, and output a first key-value generated in the prefill operation. The memory controller is configured to: store the first key-value into the non-volatile memory device, and obtain the first key-value from the non-volatile memory device, perform a decode attention operation for the large model inference, and store a second key-value generated in the decode attention operation into the non-volatile memory device.

### CROSS-REFERENCE TO RELATED APPLICATIONS

This application is a continuation of International Application No. PCT/CN2025/089667, filed on Apr. 17, 2025, the disclosure of which is hereby incorporated by reference in its entirety.

### FIELD OF TECHNOLOGY

The present disclosure relates to semiconductor technology field, relates to but is not limited to, a system and a method of operating thereof, a memory system and a method of operating thereof, and a computer readable storage medium.

### BACKGROUND

With the rapid development of data storage technologies, more and more data storage systems appear in electronic devices used by people, for example: Solid State Drives (SSDs), etc. The SSDs have been widely used in the fields such as military, vehicle-mounted, industrial, medical, aviation and the like due to their characteristics of fast read-write speed, vibration resistance, low power consumption, no noise, low heat, light weight and the like.

### SUMMARY

According to a first aspect of the examples of the present disclosure, a system is provided, comprising a processor, a non-volatile memory device, and a memory controller coupled to the non-volatile memory device; wherein the processor is configured to: perform a prefill operation for large model inference, and output a first key-value generated in the prefill operation; the memory controller is configured to: store the first key-value into the non-volatile memory device; and obtain the first key-value from the non-volatile memory device, perform a decode attention operation for the large model inference, and store a second key-value generated in the decode attention operation into the non-volatile memory device.

In some aspects, the non-volatile memory device is configured to store the first key-value and the second key-value in a manner of storing one bit of data in each memory cell.

In some aspects, the non-volatile memory device comprises a three-dimensional NAND-type memory device.

In some aspects, the processor is configured to: receive a projection output of the decode attention operation from the memory controller and perform a decode feed-forward neural network operation.

In some aspects, the processor is configured to: obtain a corresponding first query, Key and Value based on each token in a prompt input by a user, wherein the first key-value comprises the corresponding Key and Value obtained based on each token in the prompt input by the user.

In some aspects, the non-volatile memory device is configured to store a first weight required in the decode attention operation.

In some aspects, the memory controller is configured to: obtain a first weight required in the decode attention operation; and generate a projection output and the second key-value based on the first key-value and the first weight in the decode attention operation.

In some aspects, in the decode attention operation, the memory controller is configured to: generate a corresponding second query, Key and Value based on the first weight and an input vector, the second key-value comprising the corresponding Key and Value generated based on the first weight and the input vector; obtain an attention score based on a key in the first key-value, a key in the second key-value, and the second query; obtain an attention weight based on the attention score; obtain a weighted output based on the attention weight, a value in the first key-value, and a value in the second key-value; and obtain the projection output based on the weighted output and the first weight.

In some aspects, the system further comprises a volatile memory device coupled with the processor; the volatile memory device configured to store a second weight required in the decode feed-forward neural network operation.

In some aspects, the processor is configured to: obtain a second weight required in the decode feed-forward neural network operation; and generate an inference output result based on the second weight and the projection output in the decode feed-forward neural network operation.

In some aspects, the system comprises a memory system and a host coupled with the memory system; the memory system comprises the non-volatile memory device, the memory controller, and a first interface circuit, the host comprises the processor, the volatile memory device, and a second interface circuit; the memory controller interacts with the processor through the first interface circuit and the second interface circuit.

According to a second aspect of the examples of the present disclosure, a memory system is provided, comprising: a non-volatile memory device and a memory controller coupled to the non-volatile memory device, wherein the memory controller is configured to: receive a first key-value, and store the first key-value into the non-volatile memory device, wherein the first key-value comprises a Key and a Value generated in performing a prefill operation for large model inference; and obtain the first key-value from the non-volatile memory device, perform a decode attention operation for the large model inference, and store a second key-value generated in the decode attention operation into the non-volatile memory device.

In some aspects, the non-volatile memory device is configured as memory cells storing the first key-value and the second key-value in a manner of storing one bit of data in each memory cell.

In some aspects, the non-volatile memory device comprises a three-dimensional NAND-type memory device.

In some aspects, the memory controller is configured to: transmit a projection output of the decode attention operation to a processor coupled to the memory controller to cause the processor to perform a decode feed-forward neural network operation based on the projection output.

In some aspects, the non-volatile memory device is configured to store a first weight required in the decode attention operation.

In some aspects, the memory controller is configured to: obtain a first weight required in the decode attention operation; and generate a projection output and the second key-value based on the first key-value and the first weight in the decode attention operation.

According to a third aspect of the examples of the present disclosure, a method of operating a system is provided, comprising: performing, by a processor, a prefill operation for large model inference, and outputting a first key-value generated in the prefill operation; storing, by a memory controller, the first key-value into a non-volatile memory device coupled to the memory controller; and obtaining, by the memory controller, the first key-value from the non-volatile memory device, performing a decode attention operation for the large model inference, and storing a second key-value generated in the decode attention operation into the non-volatile memory device.

In some aspects, the non-volatile memory device is configured to store the first key-value and the second key-value in a manner of storing one bit of data in each memory cell.

In some aspects, the non-volatile memory device comprises a three-dimensional NAND-type memory device.

In some aspects, the method of operating the system further comprises: receiving, by the processor, a projection output of the decode attention operation from the memory controller, and performing a decode feed-forward neural network operation.

In some aspects, the performing, by a processor, a prefill operation for large model inference comprises: obtaining, by the processor, a corresponding first query, Key and Value based on each token in a prompt input by a user, wherein the first key-value comprises a corresponding Key and Value that are obtained based on each token in the prompt input by the user.

In some aspects, the non-volatile memory device is configured to store a first weight required in the decode attention operation.

In some aspects, the method of operating the system further comprises: obtaining, by the memory controller, a first weight required in the decode attention operation; and the performing, by the memory controller, a decode attention operation for the large model inference comprises: generating, by the memory controller, a projection output and the second key-value based on the first key-value and the first weight.

In some aspects, the generating, by the memory controller, a projection output and the second key-value based on the first key-value and the first weight comprises: generating, by the memory controller, a corresponding second query, Key and Value based on the first weight and an input vector; the second key-value comprises a corresponding Key and Value generated based on the first weight and the input vector; obtaining, by the memory controller, an attention score based on a key in the first key-value, a key in the second key-value, and the second query; obtaining, by the memory controller, an attention weight based on the attention score; obtaining, by the memory controller, a weighted output based on the attention weight, a value in the first key-value, and a value in the second key-value; and obtaining, by the memory controller, the projection output based on the weighted output and the first weight.

In some aspects, the system further comprises a volatile memory device coupled with the processor; the volatile memory device is configured to store a second weight required in the decode feed-forward neural network operation.

In some aspects, the method of operating the system further comprises: obtaining, by the processor, a second weight required in the decode feed-forward neural network operation; and the performing, by the processor, the decode feed-forward neural network operation comprises: in the decode feed-forward neural network operation, generating, by the processor, an inference output result based on the second weight and the projection output.

According to a fourth aspect of the examples of the present disclosure, a method of operating a memory system is provided, comprising: receiving a first key-value, and storing the first key-value into a non-volatile memory device, the first key-value comprises a Key and a Value generated in performing a prefill operation for large model inference; and obtaining the first key-value from the non-volatile memory device, performing a decode attention operation for the large model inference, and storing a second key-value generated in the decode attention operation into the non-volatile memory device.

In some aspects, the non-volatile memory device is configured to store the first key-value and the second key-value in a manner of storing one bit of data in each memory cell.

In some aspects, the non-volatile memory device comprises a three-dimensional NAND-type memory device.

In some aspects, the method of operating the memory system further comprises: transmitting a projection output of the decode attention operation to a processor coupled to the memory controller to cause the processor to perform the decode feed-forward neural network operation based on the projection output.

In some aspects, the non-volatile memory device is configured to store a first weight required in the decode attention operation.

In some aspects, the method of operating the memory system further comprises: obtaining a first weight required in the decode attention operation; and the performing a decode attention operation for the large model inference comprises: in the decode attention operation, generating a projection output and the second key-value based on the first key-value and the first weight.

According to a fifth aspect of the examples of the present disclosure, a computer readable storage medium having a computer program stored thereon is provided, the computer program, when performed by a processor, performing the method of operating the system according to any one of the above examples, and the method of operating the memory system according to any one of the above examples.

### BRIEF DESCRIPTION OF THE DRAWINGS

FIG. 1 is a first schematic diagram of an example system having a memory system in an example of the present disclosure;

FIG. 2 is a schematic diagram of an example memory card having a memory system in an example of the present disclosure;

FIG. 3 is a schematic diagram of an example solid state driver having a memory system in an example of the present disclosure;

FIG. 4 is a schematic diagram of an example memory device comprising a

peripheral circuit in an example of the present disclosure;

FIG. 5 is a schematic diagram of an example memory comprising a storage array and a peripheral circuit in an example of the present disclosure;

FIG. 6 is a second schematic diagram of an example system having a memory system in an example of the present disclosure;

FIG. 7 is a first schematic diagram of a system in an example of the present disclosure;

FIG. 8 is a second schematic diagram of a system in an example of the present disclosure;

FIG. 9 is a schematic flowchart of a decode operation in an example of the present disclosure;

FIG. 10 is a schematic diagram of a memory system in an example of the present disclosure;

FIG. 11 is a flowchart of a method of operating a system in an example of the present disclosure;

FIG. 12 is a flowchart of a method of operating a memory system in an example of the present disclosure;

FIG. 13 is a schematic diagram of a computer readable storage medium in an example of the present disclosure.

### DETAILED DESCRIPTION

Example aspects of the present disclosure will be described in more detail below with reference to the accompanying drawings. Although example aspects of the present disclosure are shown in the drawings, it should be understood that the present disclosure may be implemented in various forms and should not be limited by the specific examples set forth herein. Rather, these examples are provided so that the present disclosure can be more thoroughly understood, and the scope of the disclosure can be completely conveyed to those skilled in the art.

In the following description, numerous specific details are given in order to provide a more thorough understanding of the present disclosure. However, it will be apparent to those skilled in the art that the present disclosure may be practiced without one or more of these details. In other examples, to avoid confusion with the present disclosure, some technical features known in the art are not described; that is, all features of actual examples are not described herein, and well-known functions and structures are not described in detail.

In the drawings, like reference numerals refer to like elements throughout.

It should be understood that spatial relationship terms such as “under,” “below,” “lower,” “beneath,” “above,” “upper,” and the like may be used herein for ease of description to describe a relationship between one element or feature and other elements or features shown in the figures. It should be appreciated that the spatial relationship terms are intended to comprise different orientations of the device in use and operation in addition to the orientations shown in the figures. For example, if the devices in the figures are flipped, then the elements or features described as being “under” or “beneath” or “below” other elements will be oriented “on” other elements or features. Thus, the example terms “under” and “below” can comprise both upper and lower orientations. The device may additionally be oriented (rotated 90 degrees or other orientation) and the spatial description terms used herein are interpreted accordingly.

The terminology used herein is for the purpose of describing specific examples only and not as a limitation of the present disclosure. As used herein, the “a,” “an,” and “the” in the singular are also intended to comprise the one in the plural unless the context clearly indicates otherwise. It should also be understood that the terms at least one of “include” or “comprise” when used in this specification, determine the presence of at least one of stated features, integers, steps, operations, elements or components, but do not preclude the presence or addition of at least one of one or more other features, integers, steps, operations, elements, components or groups. As used herein, the term “at least one of” comprises any and all combinations of related listed items.

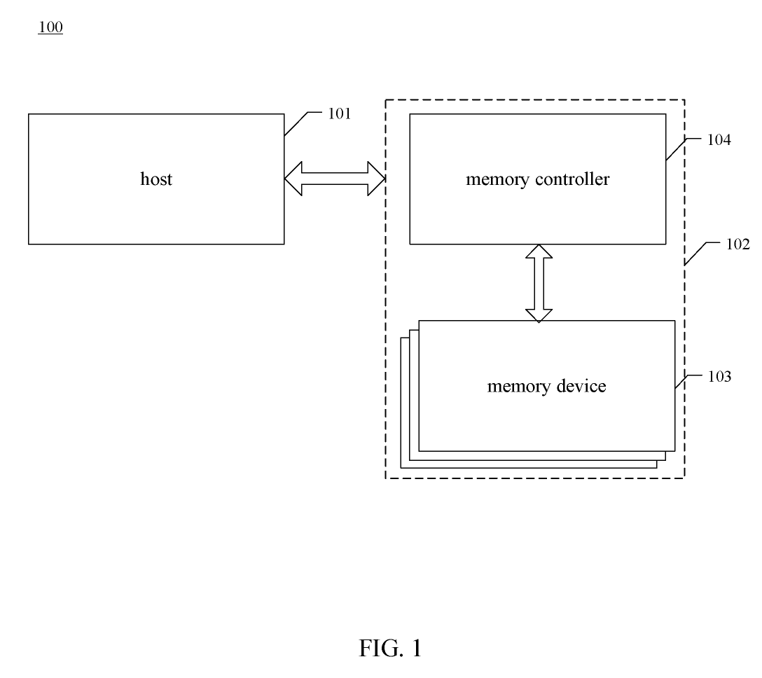

FIG. 1 is a schematic diagram of an example system having a memory system provided by an example of the present disclosure. In the examples of the present disclosure, the system 100 may be a mobile phone, a desktop computer, a laptop computer, a tablet computer, a vehicle computer, a game console, a printer, a positioning device, a wearable electronic device, an intelligent sensor, a Virtual Reality (VR) device, an Augmented Reality (AR) device, or any other suitable electronic device having a memory therein. As shown in FIG. 1, system 100 may comprise a host 101 and a memory system 102, which may comprise one or more memory devices 103 and a memory controller 104. The host 101 may comprise a processor of an electronic device, for example, a Central Processing Unit (CPU), or a System on a Chip (SoC), for example, an Application Processor (AP). The host 101 may be configured to transmit data to the memory system 102, or receive data from the memory system 102.

In some aspects, the memory controller 104 is coupled to the memory device 103 and the host 101 and is configured to control the memory device 103. The memory controller 104 may manage data stored in the memory device 103 and communicate with the host 101. In some aspects, the memory controller 104 is designed for operation in a low duty cycle environment, such as operation in a secure digital card, a Compact Flash Card (CFC), a Universal Serial BUS (USB) flash driver, or operation in other medium for use in electronic devices such as personal calculators, digital cameras, mobile phones, etc. In other examples, the memory controller 104 is designed for operation in a high duty cycle environment, such as operation in a solid state drive or an Embedded Multi-Media Card (eMMC).

In some aspects, the memory controller 104 and the one or more memory devices 103 may be integrated into various types of storage devices, that is, the memory system 102 may be implemented and packaged into different types of terminal electronic products.

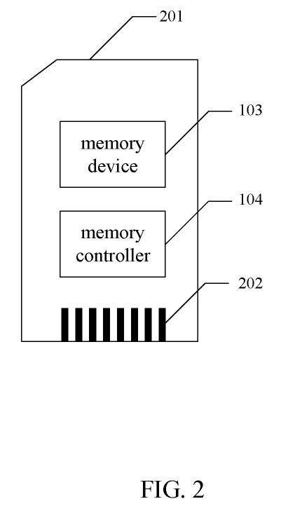

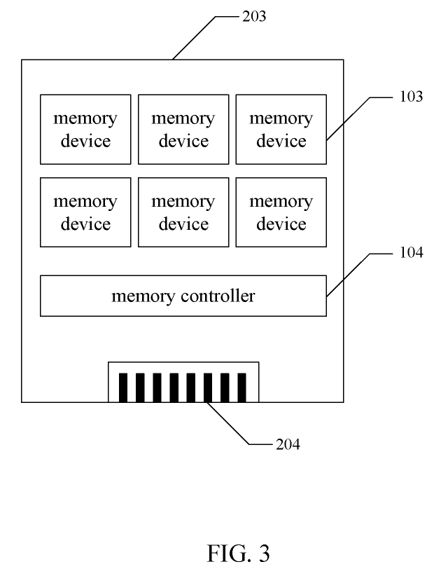

In one example as shown in FIG. 2, the memory controller 104 and the single memory device 103 may be integrated into the memory card 201. The memory card 201 may be one of a compact flash memory card, a Smart Media Card (SMC), a Memory Stick (MS), a Multi-Media Card (MMC), such as an RS-MMC, an MMCmicro, an eMMC, or the like, a secure digital card, such as a Mini SD card, a Micro SD card, an SDHC card, or the like, or a universal flash memory card. The memory card 201 may also comprise a memory card connector 202 that couples the memory card 201 with a host-side device (e.g., host 101 in FIG. 1). In another example as shown in FIG. 3, the memory controller 104 and the plurality of memory devices 103 may be integrated into SSD203. SSD203 may also comprise an SSD connector 204 that couples SSD203 with a host-side device (e.g., host 101 in FIG. 1). In some aspects, at least one of the storage capacity or operating speed of SSD203 is greater than at least one of the storage capacity or operating speed of memory card 201.

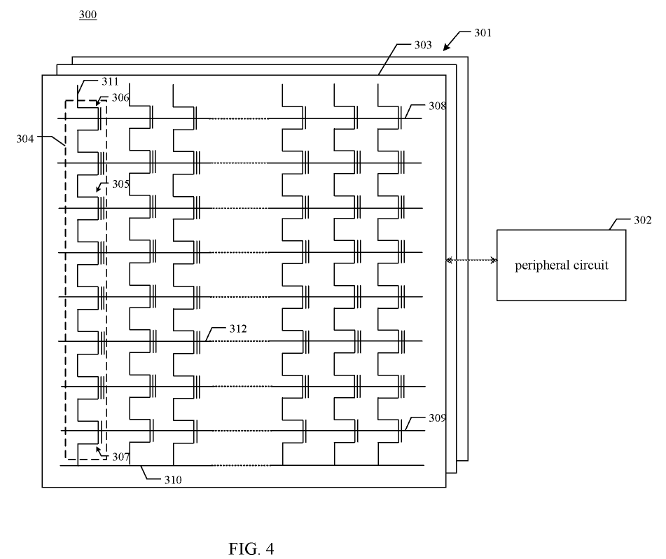

FIG. 4 is a circuit schematic diagram of an example memory device 300 comprising a peripheral circuit provided by an example of the present disclosure. Memory device 300 may be an example of memory device 103 in FIG. 1. The memory device 300 may comprise a storage array 301 and a peripheral circuit 302 coupled to the storage array 301. Taking the storage array 301 as a three-dimensional NAND storage array as an example, the memory cells 305 are NAND memory cells, the memory cells 305 are provided in the form of an array of memory cell strings 304, and each memory cell string 304 extends vertically above a substrate (not shown). In some aspects, each memory cell string 304 comprises a plurality of memory cells 305 coupled in series and stacked vertically. Each memory cell 305 may hold a continuous analog value, e.g., voltage or charge, which depends on the number of electrons trapped within the region of the memory cell 305. Each memory cell 305 may comprise a floating gate type memory cell comprising a floating gate transistor or a charge trapping type memory cell comprising a charge trapping transistor.

In some aspects, each memory cell 305 comprises a Single Level Cell (SLC) which has two possible memory states and thus can store one bit of data. For example, a first memory state “0” may correspond to a first voltage range and a second memory state “1” may correspond to a second voltage range. In some aspects, each memory cell 305 comprises a Multi-Level Cell which can store more than a single bit of data in four or more memory states, e.g., a Multi-Level Cell (MLC) storing two bits per cell, a Triple Level Cell (TLC) storing three bits per cell, or a Quad-Level Cell (QLC) storing four bits per cell.

As shown in FIG. 4, each memory cell string 304 may comprise a Bottom Select Transistor (BST) 307 at its source terminal and a Top Select Transistor (TST) 306 at its drain terminal. The bottom select transistor 307 and the top select transistor 306 may be configured to activate a selected memory cell string 304 during read and programming operations. In some aspects, the sources of the memory cell strings 304 in the same storage block 303 may be coupled through a Common Source Line (CSL) 310. In other words, all memory cell strings 304 in the same storage block 303 have an Array Common Source (ACS). According to some aspects, the top select transistor 306 of each memory cell string 304 is coupled to a respective Bit Line (BL) 311 from which data can be read or written via an output bus (not shown). In some aspects, each memory cell string 304 is configured to be selected or deselected by at least one of applying a select voltage (e.g., a voltage above a threshold voltage of the top select transistor 306) or a deselect voltage (e.g., 0V) to a Top Select Gate (TSG) of the respective top select transistor 306 through one or more Top Select Lines (TSL) 308 or applying a select voltage (e.g., a voltage above a threshold voltage of the bottom select transistor 307) or a deselect voltage (e.g., 0V) to a Bottom Select Gate (BSG) of the respective bottom select transistor 307 through one or more Bottom Select Lines (BSL) 309.

As shown in FIG. 4, the memory cell string 304 may be organized into a plurality of storage blocks 303, each of which may have the common source line 310. In some aspects, each storage block 303 is a basic unit of data for an erase operation, i.e., all memory cells 305 on the same storage block 303 are erased simultaneously. To erase memory cells 305 in a selected storage block, the common source line 310 coupled to the selected storage block and unselected storage blocks on the same side as the selected storage block may be biased with an erase voltage. It should be appreciated that in some aspects, the erase operation may be performed at a half storage block level, at a quarter storage block level, or at a level having any suitable number of storage blocks or any suitable fraction of storage blocks. The memory cells 305 of adjacent memory cell strings 304 may be coupled by word lines 312 that select which row of memory cells 305 is affected by a read or programming operations.

In some aspects, the peripheral circuit 302 may comprise any suitable analog, digital, and mixed signal circuit for implementing operation of storage array 301 by applying at least one of voltage signal or current signal to each target memory cell 305 and sensing at least one of voltage signal or current signal from each target memory cell 305 through the bit line 311, the word line 312, the common source line 310, the bottom select line 309, and the top select line 308. The peripheral circuit 302 may comprise various types of peripheral circuit formed using metal-oxide-semiconductor technology.

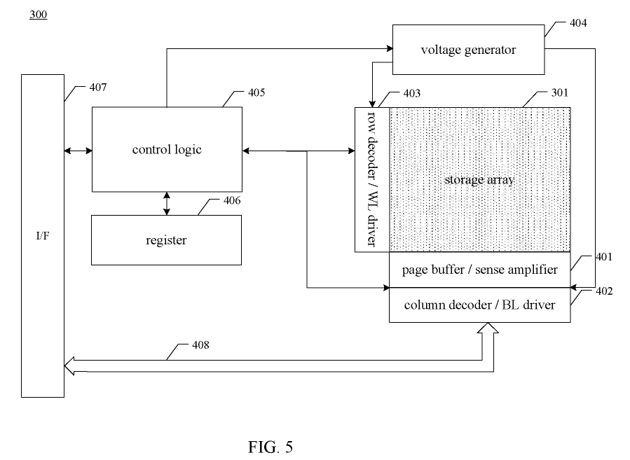

FIG. 5 illustrates some example peripheral circuit 302 comprising a page buffer/sense amplifier 401, a column decoder/bit line driver 402, a row decoder/word line driver 403, a voltage generator 404, a control logic 405, a register 406, a flash interface 407, and a data bus 408. It should be understood that in some aspects, additional peripheral circuit not shown in FIG. 5 may also be included.

The page buffer/sense amplifier 401 may be configured to read data from the storage array 301 and program (write) data into the storage array 301 according to control signals from the control logic 405. In one example, the page buffer/sense amplifier 401 may store a page of programming data (read-in data) to be programmed to the storage array 301. In another example, the page buffer/sense amplifier 401 may perform a programming verification operation to ensure that data has been correctly programmed into memory cells coupled to a selected word line. In yet another example, the page buffer/sense amplifier 401 may also sense a low power signal from a bit line representing a data bit stored in a memory cell and amplify a small voltage swing to an identifiable logic level in a read operation. The column decoder/bit line driver 402 may be configured to be controlled by the control logic 405 and to select one or more memory cell strings by applying a bit line voltage generated from voltage generator 404.

The row decoder/word line driver 403 may be configured to be controlled by the control logic 405 and select/deselect the storage block of the storage array 301 and select/deselect the word line of the storage block. The row decoder/word line driver 403 may also be configured to drive the word line using a word line voltage generated from the voltage generator 404. In some aspects, the row decoder/word line driver 403 may also select/deselect and drive the bottom select line and the top select line. As described in detail below, the row decoder/word line driver 403 is configured to perform programming operations on memory cells coupled to (one or more) selected word line(s). The voltage generator 404 may be configured to be controlled by the control logic 405 and generate a word line voltage (e.g., a read voltage, a programming voltage, a pass voltage, a local voltage, a verification voltage, etc.), a bit line voltage, and a source line voltage to be supplied to the storage array 301.

The control logic 405 may be implemented in the peripheral circuit described above and couple various portions of the peripheral circuit, and the control logic 405 may be configured to control the operation of each peripheral circuit. The register 406 may be coupled to the control logic 405 and may comprise a status register, a command register, and an address register for storing status information, command opcodes (OP codes), and command addresses for controlling the operation of each peripheral circuit. The flash interface 407 may be coupled to the control logic 405 and act as a control buffer to buffer the control commands received from a host-side device (not shown) and relay them to the control logic 405 and to buffer the status information received from the control logic 405 and relay them to the memory controller. The flash interface 407 may also be coupled to column decoder/bit line driver 402 via the data bus 408 and act as a data I/O interface and a data buffer to buffer data and relay them to the storage array 301 or relay or buffer data from the storage array 301.

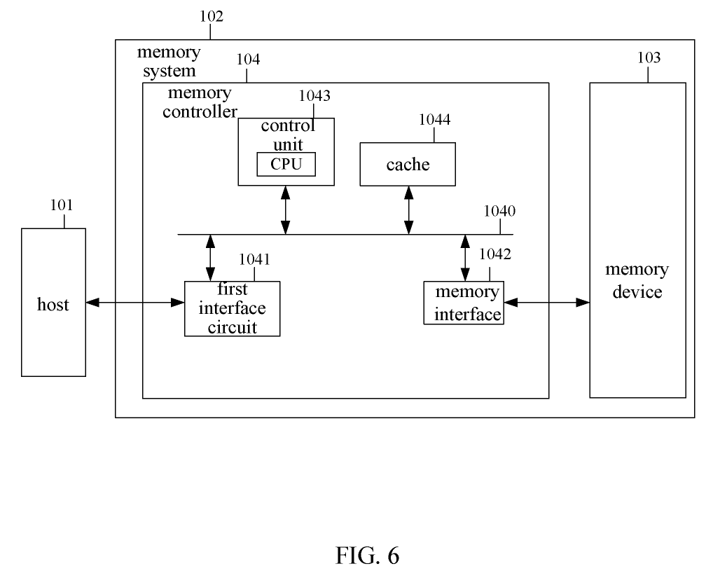

FIG. 6 is a schematic diagram of a system comprising a host and a memory system provided by an example of the present disclosure, as shown in FIG. 6, the memory system 102 is connected to the host 101, wherein the memory system 102 may comprise a memory controller 104 and a memory device 103, the memory controller 104 is configured to control the memory device 103 to perform operations such as read, write, and erase, and the memory controller 104 and the memory device 103 may also be coupled in any suitable manner. The memory controller 104 may comprise a first interface circuit 1041, a memory interface (I/F) 1042, a control unit 1043, a cache 1044, and a bus 1040. The first interface circuit 1041 may be a connection interface connecting between the host 101 and the memory controller 104, and the first interface circuit 1041 allows the host 101 and the memory controller 104 to communicate according to a specific protocol, transmit read and write requests, and perform other operations. The memory interface 1042 may be a connection interface between the memory controller 104 and the memory device 103. The memory interface 1042 is configured to implement the data and command transmission between the memory controller 104 and the memory device 103. The control unit 1043 is configured to integrally control the memory system 102.

In some aspects, the control unit 1043 may comprise one or more units having a logic operation capability, such as at least one of a Central Processing Unit (CPU) or a Microcontroller Unit (MCU).

In some aspects, the cache 1044 is configured to cache data, and may be a volatile memory device with a relatively fast read-write speed, such as at least one of a Static Random-Access Memory (SRAM) or a Dynamic Random-Access Memory (DRAM).

With the rapid development of computer technologies, large models can exert their capabilities in many scenarios due to their superior data processing capabilities. Large model inference can be classified into various types according to the type of model, application scenario and optimization mode, and each type has its unique characteristics and applicable scenario. The following are several common large model inference types and characteristics thereof: 1, a general large model, which is characterized in that: focusing on language generation, context understanding and natural language processing; generating the content conforming to the context by training massive text data and mastering the rule of the language; performing well in tasks such as text generation, translation, question answering and abstract; the application scenario comprises text generation, machine translation and question answering systems. 2. The inference large model, which is characterized in that: on the basis of a traditional large language model, being constructed by reinforcement inference, logic analysis and decision capability; integrating technical means such as reinforcement learning, neural symbol inference and meta-learning, such that the complex problem solving capability is improved; performing excellently in the aspects of logic inference, mathematical derivation and real-time problem solving; and the application scenario of the inference large model comprises mathematical justification, logic analysis and complex problem solving. 3. The multimodal large model is characterized in that: being capable of processing various types of input data, such as texts, images, audios, videos and the like; understanding the relationship between different modal data by cross-modal learning; the output of multiple modalities can be generated, such as generating an image according to the text or generating a description according to the image; and the application scenario of the multimodal large model comprises cross-modal retrieval, visual question answering and image description generation. 4. The domain-specific large model is characterized in that: optimizing for specific industry or domain, pre-training or fine tuning using industry-related data; improving the performance and accuracy in a specific domain; and the application scenario of the domain-specific large model comprises medical diagnosis, financial analysis and legal consultation. 5. The coding large model is characterized in that: focusing on code generation and programming assistance; learning the syntax and logic of programming language by training on a code repository; and application scenario of the coding large model comprises code generation, programming assistance and code completion.

The advent and rapid development of large models bring a revolution to the field of artificial intelligence, and all of the core processes of the above various types of large model inference may comprise two main stages: a Prefill stage and a Decode stage. The execution of operations related to large model inference depends on corresponding hardware.

The prefill stage is a process from inputting a prompt by a user to generating a first output Token, and is mainly responsible for processing input text, calculating and caching Key and Value, and generating the first output token. The process of prefill stage comprises: (1) input processing: after a user inputs a complete text prompt, a model (for example, the corresponding hardware relied upon by the operations related to large models) splits the input prompt into individual tokens; (2) forward propagation calculation: the model (for example, the corresponding hardware relied upon by the operations related to large models) performs forward propagation calculation on the input tokens, in this process, the model (for example, the corresponding hardware relied upon by the operations related to large models) would calculate and cache the Key and the Value corresponding to each token, and the Keys and Values are used for a subsequent decode stage to accelerate generation of the subsequent tokens; (3) generating a first output token: based on a forward propagation result of the input token, the model (for example, the corresponding hardware relied upon by the operations related to large models) would predict and generate a first output token, and the first output token is the first output content predicted by the model (for example, the corresponding hardware relied upon by the operations related to large models) according to the semantics and context information of the input prompt; and (4) outputting and caching: after the first output token is generated, the model (for example, the corresponding hardware relied upon by the operations related to large models) outputs the first output token; meanwhile, the model (for example, the corresponding hardware relied upon by the operations related to large models) would cache the calculated Key and Value into a key-value cache (KV Cache), and these cached information is used for a subsequent decode stage to help the model (for example, the corresponding hardware relied upon by the operations related to large models) to generate subsequent output tokens more efficiently.

The decode stage is mainly responsible for generating subsequent output tokens one by one after the first output token is generated until a condition of inference stop is reached. The decode stage is a process of loop iteration, and each round of iteration generates an output token until at least one of stop conditions such as reaching a maximum output length, generating a terminator, or other custom conditions is satisfied. In each round of iteration, an output token generated in a previous round would be used as a current input, a probability distribution of a next output token is calculated in combination with the previously cached Key and Value, and a token is selected from the probability distribution (usually a token with a highest probability) as an output of the current round. In each iteration, the newly generated Key and Value of the output token would be updated to the KV Cache for the next iteration.

In some examples, the Keys and Values generated in the prefill stage and the decode stage are cached in the volatile memory device in the host, that is, the volatile memory device in the host would be used as the KV Cache, and the volatile memory device herein is, for example, a dynamic random access memory such as a Low Power Double Data Rate SDRAM (LPDDR) and a Video Random Access Memory (VRAM), etc. As the data processed in the large model inference becomes larger and larger, the capacity requirement of the KV Cache becomes larger and larger, such that the cost of the KV Cache becomes larger and larger. In some application scenarios, the capacity of the KV Cache is close to or even exceeds the capacity of the volatile memory device itself in the host. How to reduce the cost of the KV Cache becomes an urgent problem to be solved at the present stage.

In this regard, the present disclosure proposes the following aspects.

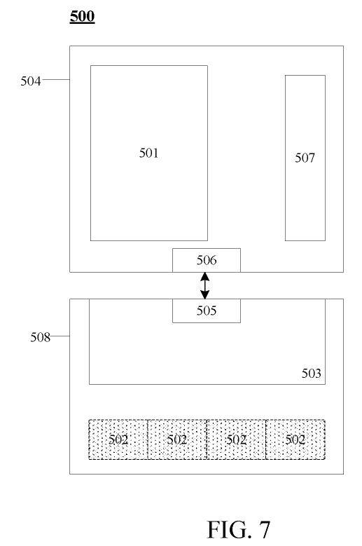

The present disclosure provides a system, FIG. 7 is a schematic diagram of a system provided by an example of the present disclosure, and as shown in FIG. 7, the system 500 comprises a processor 501, a non-volatile memory device 502, and a memory controller 503 coupled to the non-volatile memory device 502; wherein the processor 501 is configured to: perform a prefill operation for large model inference, and output a first key-value generated in the prefill operation; the memory controller 503 is configured to: store the first key-value into the non-volatile memory device 502; and obtain the first key-value from the non-volatile memory device 502, perform a decode attention operation for the large model inference, and store a second key-value generated in the decode attention operation into the non-volatile memory device 502.

In the example of the present disclosure, the processor 501 performs a prefill operation for the large model inference and generates a first key-value; the memory controller 503 stores the first key-value into the non-volatile memory device 502; and the memory controller 503 obtains the first key-value from the non-volatile memory device 502, performs the decode attention operation for the large model inference, and the memory controller 503 stores a second key-value generated in the decode attention operation into the non-volatile memory device 502. That is, the first key-value and the second key-value generated in the large model inference process in the examples of the present disclosure may be stored into the non-volatile memory device 502, and the memory controller 503 directly obtains the first key-value from the non-volatile memory device 502 coupled to the memory controller 503 and performs the decode attention operation. An example of the present application takes a non-volatile memory device 502 as the key-value cache, such that the capacity and cost of the key-value cache in the large model inference process can be improved.

In the examples of the present disclosure, the large model inference may process various types of data, comprising but not limited to text data, audio data, video data, structural data, code data, and multimodal data.

In some aspects, the processor 501 comprises, but is not limited to, a CPU, a Graphics Processing Unit (GPU), a Tensor Processing Unit (TPU), and a Neural network Processing Unit (NPU).

The system 500 in the examples of the present disclosure comprises, but is not limited to, a mobile phone, a desktop computer, a laptop computer, a tablet computer, a vehicle computer, a game console, a printer, a positioning device, a wearable electronic device, a smart sensor, a virtual reality device, an augmented reality device, or any other suitable electronic device having a memory therein.

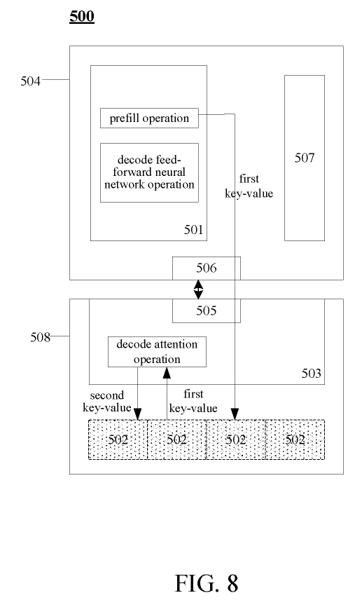

In some aspects, as shown in FIG. 8, the processor 501 may perform a prefill operation to generate a first key-value, the processor 501 outputs the first key-value to the memory controller 503, and the memory controller 503 stores the first key-value into the non-volatile memory device 502.

In some aspects, the processor 501 is configured to obtain a corresponding first query, the Key and Value based on each token in the prompt input by the user, wherein the first key-value comprises the corresponding Key and Value obtained based on each token in the prompt input by the user.

In the example of the present disclosure, after the user inputs a complete text prompt, the text prompt may be split into individual tokens by the tokenizer, and the tokens may be converted into numerical forms that can be understood by the system. The processor 501 performs forward propagation calculation on the input tokens, and calculates, based on each tokens in the prompt input by the user, a key, a value, and a first query that correspond to each input token. The first key-value may comprise a corresponding Key and Value obtained based on each token in the prompt input by the user in the prefill operation, and the first key-value is output by the processor 501 to the memory controller 503 and stored by the memory controller 503 into the non-volatile memory device 502 coupled to the memory controller 503 for a subsequent decode stage to accelerate the generation of the output token in the subsequent decode operation.

In some aspects, the non-volatile memory device 502 comprises a three-dimensional NAND-type memory device.

It can be understood that the three-dimensional NAND memory device can better meet the capacity requirement and cost requirement of the key-value cache in a large data environment due to its low cost and large capacity.

In some aspects, the system 500 comprises one or more non-volatile memory devices 502 with which the memory controller 503 is coupled.

In some aspects, the non-volatile memory device 502 is configured to store the first key-value and the second key-value in a manner of storing one bit of data in each memory cell.

It can be understood that, in the example of the present disclosure, the non-volatile memory device 502 is configured to store the first key-value and the second key-value in a manner of storing one bit of data in each memory cell, and the memory cell of the non-volatile memory device 502 has a faster read-write speed in a mode of storing one bit of data, such that the efficiency of the large model inference can be improved, and the inference time can be saved.

The non-volatile memory device 502 in the examples of the present disclosure is not limited to the three-dimensional NAND-type memory device presented in the above examples, and the non-volatile memory device 502 in the examples of the present disclosure may further comprise a non-volatile memory device such as a three-dimensional phase change memory.

It can be understood that the three-dimensional phase change memory device also has a relatively fast read-write speed, relatively large capacity, relatively low cost, and can meet the requirements of the large model inference on capacity and efficiency.

In some aspects, the decode operation comprises a Decode Attention operation and a Decode Feed-Forward Neural Network operation.

In some aspects, the memory controller 503 is configured to: perform a decode attention operation; and store the second key-value generated in the decode attention operation into the non-volatile memory device 502.

As shown in FIG. 8, the decode attention operation in the example of the present disclosure may be performed by the memory controller 503, and the memory controller 503 stores the second key-value generated in the decode attention operation into the non-volatile memory device 502.

It can be understood that, on the basis that the first key-value and the second key-value are stored into the non-volatile memory device 502, the memory controller 503 coupled to the non-volatile memory device 502 performing the decode attention operation can shorten the time of obtaining the first key-value from the non-volatile memory device 502 and storing the second key-value into the non-volatile memory device 502, which can shorten the transmission time of the data in the decode attention operation, such that the execution efficiency of the decode attention operation may be improved.

In some aspects, the above decode attention operation may be performed by a control unit in the memory controller 503.

In some aspects, the processor 501 is configured to: receive a projection output of the decode attention operation from the memory controller 503 and perform the decode feed-forward neural network operation.

It may be understood that, on the basis of the memory controller 503 performing the decode attention operation, the processor 501 may perform a decode feed-forward neural network operation, such that the resource allocation is more even.

In some aspects, the memory controller 503 is configured to: obtain a first weight required in the decode attention operation; and generate a projection output and a second key-value based on the first key-value and the first weight in the decode attention operation.

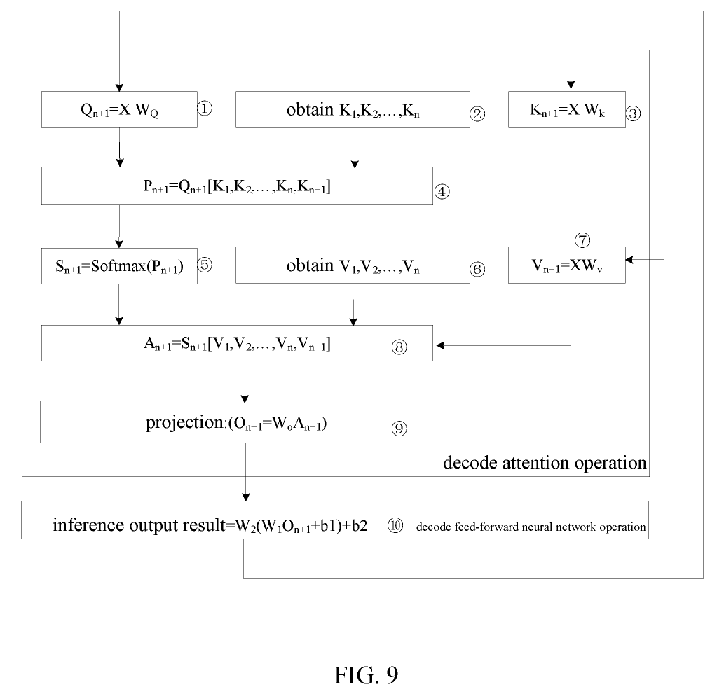

In the example of the present disclosure, the decode stage is a process of a loop iteration, and FIG. 9 shows a schematic diagram of a process of one round of iteration of a decode operation. As shown in FIG. 9, the decode operation comprises a decode attention operation and a feed-forward neural network operation. In the decode attention operation stage, the memory controller 503 obtains a first weight required in the decode attention operation, where the first weight comprises a weight (W_{Q}) related to a Query, a weight (Wₖ) related to a key, a weight (Wᵥ) related to a value, and an attention weight (Wₒ), and each of the weights may be a matrix or a vector, and comprises a plurality of elements.

In some aspects, the non-volatile memory device 502 is configured to store a first weight required in the decode attention operation.

In some aspects, the memory controller 503 is configured to: obtain a first weight required in the decode attention operation from the non-volatile memory device 502; and generate a projection output and a second key-value based on the first key-value and the first weight in the decode attention operation.

It may be understood that, in the example of the present disclosure, in the case that the decode attention operation is performed by the memory controller 503, the first weight required in the decode attention operation may be stored into the non-volatile memory device 502 coupled to the memory controller 503, and the memory controller 503 may directly obtain the first weight from the non-volatile memory device 502 when performing the decode attention operation, such that the time for obtaining the first weight may be shortened, and the inference efficiency may be improved.

In some aspects, as shown in FIG. 6, the memory controller comprises a cache 1044 which is configured to store the first weight required in the decode attention operation.

In some aspects, the memory controller is configured to: obtain a first weight required in the decode attention operation from the cache; and generate a projection output and a second key-value based on the first key-value and the first weight in the decode attention operation.

It may be understood that, in the example of the present disclosure, in the case that the decode attention operation is performed by the memory controller 503, the first weight required in the decode attention operation may also be stored in the cache in the memory controller 503, and the memory controller 503 may directly obtain the first weight from the cache in the memory controller 503 when performing the decode attention operation, such that the time for obtaining the first weight may be further shortened, and the inference efficiency may be further improved.

In some aspects, in the decode attention operation, the memory controller 503 is configured to: generate a corresponding second query, Key and Value based on the first weight and a input vector; the second key-value comprises the corresponding Key and Value generated based on the first weight and the input vector; obtain an attention score based on the key in the first key-value, the key in the second key-value and the second query; obtain an attention weight based on the attention score; obtain a weighted output based on the attention weight, the value in the first key-value and the value in the second key-value; and obtain the projection output based on the weighted output and the first weight.

As shown in FIG. 9, performing the decode attention operation comprises the following process: as shown in ① in FIG. 9, the input vector (X) is linearly transformed through a weight (W_{Q}) related to the query to obtain a corresponding query (Qₙ₊₁); and as shown in ② in FIG. 9, the memory controller may obtain a related key (K1, K2, ..., .Kₙ) from the non-volatile memory device 502, wherein K₁, K₂, ..., .Kₙ comprise the key in the first key-value generated by the prefill operation and the key generated in the iteration before the current round of iteration in the decode operation; As shown in ③ in FIG. 9, the input vector (X) is linearly transformed through a weight (Wₖ) related to the key to generate a corresponding key (Kₙ₊₁); as shown in ④ in FIG. 9, the query vector (Qₙ₊₁) and all keys (comprising Kₙ₊₁ generated in the current iteration and K1, K2, ..., .Kₙ obtained from the non-volatile memory device 502) performs dot product operation to obtain an attention score Pₙ₊₁; as shown in ⑤ in FIG. 9, a Softmax function is applied to the attention score Pₙ₊₁, the attention weight Sₙ₊₁ is obtained; as shown in ⑥ in FIG. 9, the memory controller may obtain relevant values (V1, V2, ..., .Vₙ) from the non-volatile memory device 502, wherein V1, V2, ..., .Vₙ comprise the value in the first key-value generated by the prefill operation and the value generated in the iteration before the current iteration in the decode operation; as shown in ⑦ in FIG. 9, the input vector (X) is linearly transformed through the weight (Wᵥ) related to the value to obtain a corresponding value (Vₙ₊₁); as shown in ⑧ in FIG. 9, all values (comprising Vₙ₊₁generated in the current iteration and V1, V2, ..., .Vₙ obtained from the non-volatile memory device 502) are weighted and summed using the attention weight (Sₙ₊₁) to obtain a weighted output (An+1); as shown in ⑨ in FIG. 9, Projection: the weighted output (Aₙ₊₁) is linearly transformed through the attention weight (Wₒ) to obtain the projection output (Oₙ₊₁). The key (Kₙ₊₁), value (Vₙ₊₁) generated in the current round of iteration may be stored into the non-volatile memory device 502 for the next round of iteration.

In the example of the present disclosure, the second key-value may comprise the Keys and Values generated in each round of iteration of the decode attention operation.

In some aspects, the processor 501 is configured to: obtain a second weight required in the decode feed-forward neural network operation; and generate an inference output result based on the second weight and the projection output in the decode feed-forward neural network operation.

In the example of the present disclosure, the projection output generated by the memory controller 503 performing the decode attention operation may be transmitted to the processor 501, and the processor 501 performs the decode feed-forward neural network operation.

As shown in FIG. 9, in the stage of the decode feed-forward neural network operation, the processor 501 obtains a second weight required in the decode feed-forward neural network operation and a projection output generated by the decode attention operation, wherein the second weight comprises the weights (W₁ and W₂) of the feed-forward neural network, and each of the weights may be a matrix or a vector, and comprises a plurality of elements.

As shown in ⑩ in FIG. 9, the projection output (Oₙ₊₁) is further processed through a feed-forward neural network (comprising two linear transformations and a nonlinear activation function) to obtain an inference output result (Output). The b1 and b2 herein are bias terms. The inference output result (Output) generated in the current iteration may be used for the next iteration.

In some aspects, as shown in FIGS. 7 and 8, the system 500 further comprises a volatile memory device 507 coupled to the processor 501; the volatile memory device 507 is configured to store the second weight required in the decode feed-forward neural network operation.

The volatile memory device 507 herein comprises, but is not limited to, a Random Access Memory (RAM), a Dynamic Random Access Memory, a Static Random Access Memory (SRAM), a Synchronous Dynamic Random Access Memory (SDRAM), and a Double Data Rate Synchronous Dynamic Random Access Memory (DDR SDRAM).

In some aspects, the processor 501 is configured to: obtain, from the volatile memory device 507, the second weight required in the decode feed-forward neural network operation.

It may be understood that in the example of the present disclosure, in the case that the decode feed-forward neural network operation is performed by the processor 501, the second weight required in the decode feed-forward neural network operation may be stored in the volatile memory device 507 coupled to the processor 501, and the processor 501 may directly obtain the second weight from the volatile memory device 507 when performing the decode feed-forward neural network operation, such that the time for obtaining the second weight may be shortened, and the inference efficiency may be improved.

In some aspects, as shown in FIGS. 7 and 8, the system 500 comprises a memory system 508 and a host 504 coupled to the memory system 508; the memory system 508 comprises a non-volatile memory device 502, a memory controller 503 and a first interface circuit 505, and the host 504 comprises a processor 501, a volatile memory device 507 and a second interface circuit 506; the memory controller 503 interacts with the processor 501 through the first interface circuit 505 and the second interface circuit 506.

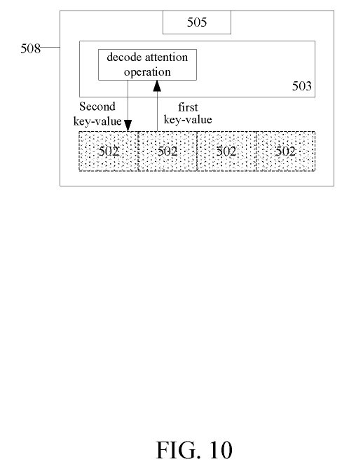

Based on the foregoing system, an example of the present disclosure further provides a memory system 508, as shown in FIG. 10, the memory system 508 comprises: a non-volatile memory device 502 and a memory controller 503 coupled to the non-volatile memory device 502; the memory controller 503 is configured to: receive a first key-value, and store the first key-value into the non-volatile memory device 502; the first key-value comprises a Key and a Value generated in performing a prefill operation for large model inference; and obtain the first key-value from the non-volatile memory device 502, perform a decode attention operation for the large model inference, and store a second key-value generated in the decode attention operation into the non-volatile memory device 502.

In the example of the present disclosure, the memory controller 503 receives the first key-value generated in the prefill operation, and the memory controller 503 stores the first key-value into the non-volatile memory device 502; and the memory controller 503 obtains the first key-value from the non-volatile memory device 502, performs the decode attention operation for the large model inference, and the memory controller 503 stores the second key-value generated in the decode attention operation into the non-volatile memory device 502. That is, both the first key-value and the second key-value generated in the large model inference process in the examples of the present disclosure may be stored into the non-volatile memory device 502, and the memory controller 503 directly obtains the first key-value from the non-volatile memory device 502 coupled to the memory controller 503 and performs the decode attention operation for the large model inference. An example of the present application takes the non-volatile memory device 502 as the key-value cache, such that the capacity and cost issue of the key-value cache in the large model inference process can be improved.

In some aspects, the non-volatile memory device 502 is configured to store the first key-value and the second key-value in a manner of storing one bit of data in each memory cell.

In some aspects, the non-volatile memory device 502 comprises a three-dimensional NAND-type memory device.

In some aspects, the memory controller 503 is configured to: transmit a projection output of the decode attention operation to the processor 501 coupled to the memory controller 503 to cause the processor 501 to perform the decode feed-forward neural network operation based on the projection output.

In some aspects, the non-volatile memory device 502 is configured to store the first weight required in the decode attention operation.

In some aspects, the memory controller 503 is configured to: obtain the first weight required in the decode attention operation; and generate the projection output and the second key-value based on the first key-value and the first weight in the decode attention operation.

Other details of the above memory system have been described in detail on the system side, and will not be repeated here for brevity.

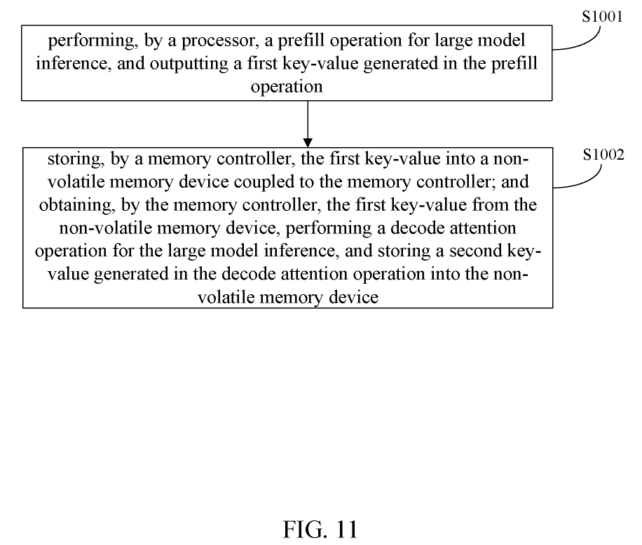

Based on the foregoing system, an example of the present disclosure further provides a method of operating a system, as shown in FIG. 11, the method of operating the system comprises the following operations: operation S1001: performing, by a processor, a prefill operation for large model inference, and outputting a first key-value generated in the prefill operation; and operation S1002: storing, by a memory controller, the first key-value into a non-volatile memory device coupled to the memory controller; and obtaining, by the memory controller, the first key-value from the non-volatile memory device, performing a decode attention operation for the large model inference, and storing a second key-value generated in the decode attention operation into the non-volatile memory device.

In some aspects, the non-volatile memory device is configured to store the first key-value and the second key-value in a manner of storing one bit of data in each memory cell.

In some aspects, the non-volatile memory device comprises a three-dimensional NAND-type memory device.

In some aspects, the method of operating the system further comprises: receiving, by the processor, a projection output of the decode attention operation from the memory controller, and performing a decode feed-forward neural network operation.

In some aspects, the performing, by the processor, a prefill operation for large model inference comprises: obtaining, by the processor, a corresponding first query, Key and Value based on each token in the prompt input by the user, wherein the first key-value comprises the corresponding Key and Value obtained based on each token in the prompt input by the user.

In some aspects, the non-volatile memory device is configured to store a first weight required in the decode attention operation.

In some aspects, the method of operating the system further comprises: obtaining, by the memory controller, the first weight required in the decode attention operation; and performing, by the memory controller, the decode attention operation for the large model inference comprises: generating, by the memory controller, a projection output and a second key-value based on the first key-value and the first weight.

In some aspects, the generating, by the memory controller, the projection output and the second key-value based on the first key-value and the first weight comprises: generating, by the memory controller, a corresponding second query, Key and Value based on the first weight and a input vector; the second key-value comprises the corresponding Key and Value generated based on the first weight and the input vector; obtaining, by the memory controller, an attention score based on a key in the first key-value, a key in the second key-value and the second query; obtaining, by the memory controller, an attention weight based on the attention score; obtaining, by the memory controller, a weighted output based on the attention weight, a value in the first key-value, a the value in the second key-value; and obtaining, by the memory controller, the projection output based on the weighted output and the first weight.

In some aspects, the system further comprises a volatile memory device coupled with the processor; the volatile memory device configured to store a second weight required in the decode feed-forward neural network operation.

In some aspects, the method of operating the system further comprises: obtaining, by the processor, the second weight required in the decode feed-forward neural network operation; and the performing, by the processor, the decode feed-forward neural network operation comprises: in the decode feed-forward neural network operation, generating, by the processor, an inference output result based on the second weight and the projection output.

The method of operating the system mentioned in the foregoing example has been described in detail in the foregoing example of the system, and for brevity, details are not described herein again.

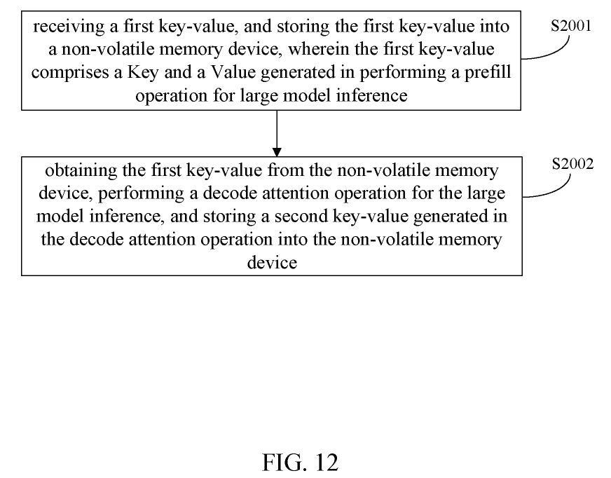

Based on the foregoing system, an example of the present disclosure further provides a method of operating a memory system, as shown in FIG. 12, the method operating of the memory system comprises the following operations: operation S2001: receiving a first key-value, and storing the first key-value into a non-volatile memory device, wherein the first key-value comprises a Key and a Value generated in performing a prefill operation for large model inference; and operation S2002: obtaining the first key-value from the non-volatile memory device, performing a decode attention operation for the large model inference, and storing a second key-value generated in the decode attention operation into the non-volatile memory device.

In some aspects, the non-volatile memory device is configured to store the first key-value and the second key-value in a manner of storing one bit of data in each memory cell.

In some aspects, the non-volatile memory device comprises a three-dimensional NAND-type memory device.

In some aspects, the method operating of the memory system further comprises: transmitting a projection output of the decode attention operation to the processor coupled to the memory controller to cause the processor to perform the decode feed-forward neural network operation based on the projection output.

In some aspects, the non-volatile memory device is configured to store a first weight required in the decode attention operation.

In some aspects, the method operating of the memory system further comprises: obtaining a first weight required in the decode attention operation; and performing the decode attention operation for the large model inference comprises: in the decode attention operation, generating the projection output and the second key-value based on the first key-value and the first weight.

The method of operating the memory system mentioned in the foregoing examples has been described in detail in the foregoing examples of the system, and for brevity, details are not described herein again.

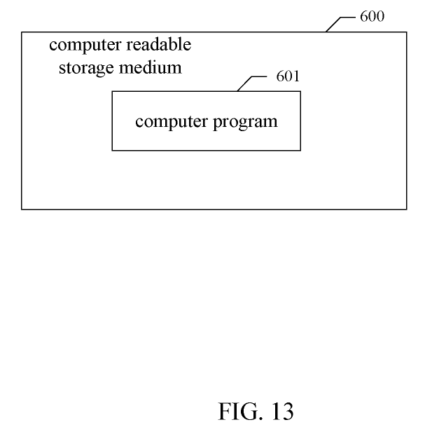

As shown in FIG. 13, an example of the present disclosure further provides a computer readable storage medium 600, wherein the computer readable storage medium 600 stores a computer program 601, and when the computer program 601 is performed by a processor, the method of operating the system according to any one of the above examples and the method of operating the memory system according to any one of the above examples are performed.

Herein, all or part of the processes for implementing the method of operating the memory system and the method of operating the system in the foregoing examples may be completed by instructing related hardware by using a computer program, the program may be stored in a computer readable storage medium, and when the program is performed, the processes of the examples of the foregoing methods may be included. The storage medium may be a Ferromagnetic Random Access Memory (FRAM), a Read Only Memory (ROM), a Programmable Read-Only Memory (PROM), an Erasable Programmable Read-Only Memory (EPROM), an Electrically Erasable Programmable Read-Only Memory (EEPROM), a Flash Memory, a magnetic surface memory, an optical disc or a Compact Disc Read-Only Memory (CD-ROM), or the like; and the computer readable storage medium may further comprise a combination of the foregoing types of memories.

The features disclosed in the several device examples provided by the present disclosure may be arbitrarily combined without conflict to obtain a new device example.

The methods disclosed in the several method examples provided by the present disclosure may be arbitrarily combined without conflict to obtain new method examples.

The above description is merely specific examples of the present disclosure, but the protection scope of the present disclosure is not limited thereto, and any person skilled in the art may easily conceive of changes or substitutions within the technical scope of the present disclosure, which shall be covered within the protection scope of the present disclosure.

What is claimed is:

1. A system, comprising:
at least one processor configured to:
perform a prefill operation for large model inference; and
output a first key-value generated in the prefill operation;
a non-volatile memory device; and
a memory controller coupled to the non-volatile memory device and configured to:
store the first key-value into the non-volatile memory device;
obtain the first key-value from the non-volatile memory device,
perform a decode attention operation for the large model inference; and
store a second key-value generated in the decode attention operation into the non-volatile memory device.

2. The system of claim 1, wherein the non-volatile memory device is configured to store the first key-value and the second key-value by storing one bit of data in each memory cell.

3. The system of claim 1, wherein the non-volatile memory device comprises a three-dimensional NAND-type memory device.

4. The system of claim 1, wherein the at least one processor is configured to:
receive a projection output of the decode attention operation from the memory controller; and
perform a decode feed-forward neural network operation.

5. The system of claim 1, wherein the at least one processor is configured to:
obtain a first query, and corresponding Key and Value based on each token in a prompt input by a user, wherein the first key-value comprises the corresponding Key and Value obtained based on each token in the prompt input by the user.

6. The system of claim 4, wherein the non-volatile memory device is configured to store a first weight required in the decode attention operation.

7. The system of claim 1, wherein the memory controller is configured to:
obtain a first weight required in the decode attention operation; and
generate a projection output and the second key-value based on the first key-value and the first weight in the decode attention operation.

8. The system of claim 7, wherein in the decode attention operation, the memory controller is configured to:
generate a second query, and corresponding Key and Value based on the first weight and an input vector, wherein the second key-value comprises the corresponding Key and Value generated based on the first weight and the input vector;
obtain an attention score based on a key in the first key-value, a key in the second key-value and the second query;
obtain an attention weight based on the attention score;
obtain a weighted output based on the attention weight, a value in the first key-value and a value in the second key-value; and
obtain the projection output based on the weighted output and the first weight.

9. The system of claim 4, further comprising:
a volatile memory device coupled with the at least one processor and configured to:
store a second weight required in the decode feed-forward neural network operation.

10. The system of claim 4, wherein the at least one processor is configured to:
obtain a second weight required in the decode feed-forward neural network operation; and
generate an inference output result based on the second weight and the projection output in the decode feed-forward neural network operation.

11. The system of claim 9, comprising:
a memory system, comprising:
the non-volatile memory device;
the memory controller; and
a first interface circuit; and
a host coupled to the memory system, comprising:
the at least one processor;
the volatile memory device; and
a second interface circuit, and wherein
the memory controller interacts with the at least one processor through the first interface circuit and the second interface circuit.

12. A memory system, comprising:
a non-volatile memory device; and
a memory controller coupled to the non-volatile memory device and configured to:
receive a first key-value and store the first key-value into the non-volatile memory device, wherein the first key-value comprises a Key and a Value generated in performing a prefill operation for large model inference;
obtain the first key-value from the non-volatile memory device,
perform a decode attention operation for the large model inference; and
store a second key-value generated in the decode attention operation into the non-volatile memory device.

13. The memory system of claim 12, wherein the non-volatile memory device is configured as memory cells storing the first key-value and the second key-value by storing one bit of data in each memory cell.

14. The memory system of claim 12, wherein the non-volatile memory device comprises a three-dimensional NAND-type memory device.

15. The memory system of claim 12, wherein the memory controller is configured to:
transmit a projection output of the decode attention operation to at least one processor coupled to the memory controller to cause the at least one processor to perform a decode feed-forward neural network operation based on the projection output.

16. The memory system of claim 15, wherein the non-volatile memory device is configured to store a first weight required in the decode attention operation.

17. The memory system of claim 12, wherein the memory controller is configured to:
obtain a first weight required in the decode attention operation; and
generate a projection output and the second key-value based on the first key-value and the first weight in the decode attention operation.

18. A method of operating a system, comprising:
performing, by at least one processor, a prefill operation for large model inference, and outputting a first key-value generated in the prefill operation;
storing, by a memory controller, the first key-value into a non-volatile memory device coupled to the memory controller;
obtaining, by the memory controller, the first key-value from the non-volatile memory device;
performing, by the memory controller, a decode attention operation for the large model inference; and
storing, by the memory controller, a second key-value generated in the decode attention operation into the non-volatile memory device.

19. The method of claim 18, wherein the non-volatile memory device is configured to store the first key-value and the second key-value by storing one bit of data in each memory cell.

20. The method of claim 18, wherein the non-volatile memory device comprises a three-dimensional NAND-type memory device.
